(19) United States
(12) Patent Application Publication
(10) Pub. No.: US 2010/0275475 A1
(43) Pub. Date: Nov. 4, 2010

(54) SPRAY NOZZLE PACKAGING SYSTEM AND METHOD

(76) Inventor: Mark Mohr, Lindstrom, MN (US)

Correspondence Address: GREENBERG TRAURIG (PHX), INTELLECTUAL PROPERTY DEPARTMENT, 2450 COLORADO AVENUE , SUITE 400E, SANTA MONICA, CA, 90404, US

(21) Appl. No.: 12/432,535

(22) Filed: Apr. 29, 2009

(51) Int. Cl. G09F 3/00; G06K 19/06

(52) U.S. Cl. 40/299.01; 235/494

(57) ABSTRACT

Embodiments of the invention provide a packaging system and method of labeling two or more agricultural spray nozzle products using a base label. The method can include providing a base label including two or more spray pattern icons in a first zone and two or more droplet size icons or use icons in a second zone. The method can also include providing a spray pattern indicator adjacent to one of the spray pattern icons and providing a droplet size indicator adjacent to one of the droplet size icons or a use indicator adjacent to one of the use icons.

### BACKGROUND

Spray nozzles often have different performance and use characteristics that are not readily apparent by looking at the nozzle itself. Spray nozzles are often sold in plastic packaging with a label or card affixed to the package. This label or card must be printed with the performance and use information for each individual spray nozzle product, and must be printed in the language of the country in which the products will be sold. With many different performance and use characteristics and with all the countries in which agricultural products are sold, this can result in hundreds of different labels needing to be printed.

### SUMMARY

Some embodiments of the invention provide a packaging system and method of labeling two or more agricultural spray nozzle products using a base label. The method can include providing a base label including two or more spray pattern icons in a first zone and two or more droplet size icons or use icons in a second zone. The method can also include providing a spray pattern indicator adjacent to one of the spray pattern icons and providing a droplet size indicator adjacent to one of the droplet size icons or a use indicator adjacent to one of the use icons.

### DESCRIPTION OF THE DRAWINGS

FIG. 1 is a schematic view of a label for use with a packaging system according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

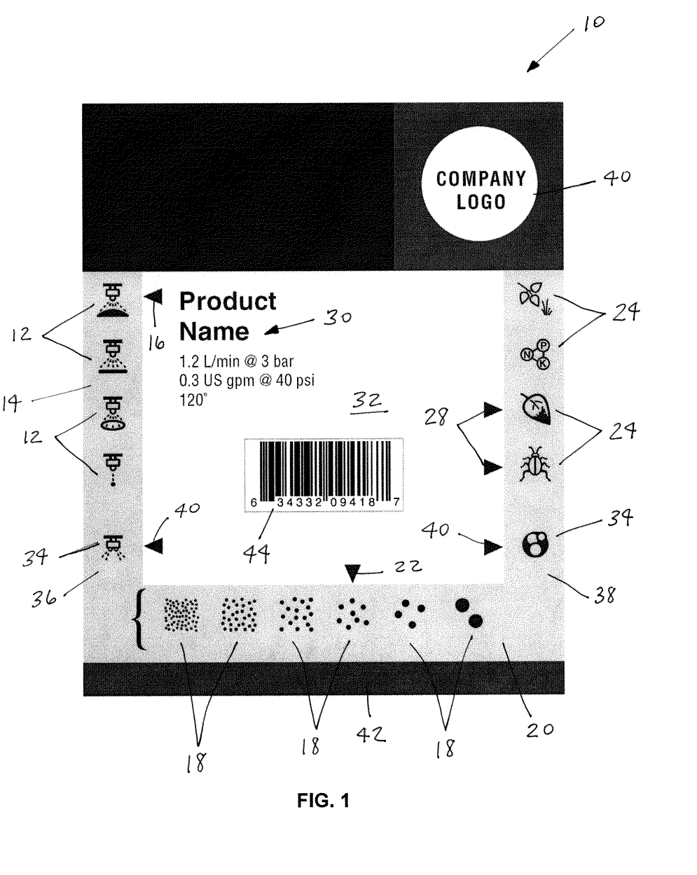

FIG. 1 illustrates a base label 10 for use with a packaging system and method according to one embodiment of the invention. As used herein and in the appended claims, the term “base label” refers to any printed adhesive label or printed card used to identify a product inside a package. The base label 10 can be attached to a suitable package, such as attached to a plastic bag, attached to a cardboard box, or inserted behind a plastic window. The base label 10 can be used for several different types of agricultural spray nozzle products without having to create completely different labels for each individual product and for each individual language for the countries in which the products will be sold.

The base label 10 can include spray pattern icons 12 in a first zone 14. In one embodiment, the first zone 14 is a vertical column of information on a left side of the base label 10. In some embodiments, the spray pattern icons 12 can include two or more of a tapered fan, an even fan, a hollow cone, and a stream (as shown from top to bottom in FIG. 1), or any other suitable spray patterns that may be produced by a spray nozzle. A spray pattern indicator 16 can be printed, affixed, or marked on the base label 10 adjacent to one of the spray pattern icons 12.

The base label 10 can also include droplet size icons 18 in a second zone 20. In one embodiment, the second zone 20 is a horizontal row on a bottom portion of the base label 10. In some embodiments, the droplet size icons 18 can include two or more of very fine, fine, medium, coarse, very coarse, and extremely coarse (as shown from left to right in FIG. 1). In one embodiment, the droplet size icons 18 can represent standard droplet size classes at a reference pressure of about three bar (or any other reference pressure suitable for the nozzle type). A droplet size indicator 22 can be printed, affixed, or marked on the base label 10 adjacent to one of the droplet size icons 18.

The base label 10 can further include use or application icons 24 in a third zone 26. In one embodiment, the third zone 26 is a vertical column on a right side of the base label 10. The use icons 24 can include two or more of weed control, fertilizer application, plant disease control, and insect control (as shown from top to bottom in FIG. 1), or any other suitable uses. One or more use indicators 28 can be printed, affixed, or marked on the base label 10 adjacent to one of the use icons 24.

The base label 10 can still further include product information 30, such as one or more of product name, reference flow rate, reference pressure, spray pattern angle, quantity, part number, date, traceability information, and product codes. The product information 30 can be printed, affixed, or marked in a fourth zone 32. In one embodiment, the fourth zone 32 is an area bounded on the left by the first zone 14, on the bottom by the second zone 20, and on the right by the third zone 26.

In addition, the base label 10 can include one or more product feature icons 34 (such as icons indicating twin spray patterns and air-induced sprays) in a fifth zone 36 and/or a sixth zone 38. In one embodiment, the fifth zone 36 is below the first zone 14. In one embodiment, the sixth zone 38 is below the third zone 26. A product feature indicator 40 can be printed, affixed, or marked on the base label 10 adjacent to one or more of the product feature icons 34.

The base label 10 can include a company logo 40 and/or company website information in a seventh zone 42. In one embodiment, the company logo 40 can be placed at a top portion of the base label 10. In one embodiment, the seventh zone 42 can be at a bottom portion of the base label 10 below the second zone 20. In some embodiments, the base label 10 can also include a bar code 44. In one embodiment, the bar code 44 can be placed in the fourth zone 32. In some embodiments, each of the indicators 16, 22, 28, and 40 can be printed, affixed, or marked in the fourth zone 32.

The base label 10 can be used for the packaging of several different types of agricultural spray nozzle products by modifying the positions of the indicators 16, 22, 28, and 40 that are printed, affixed, or marked adjacent to icons. The base label r0 can also be used for the packaging for agricultural spray nozzle products being sold in non-English speaking countries without having to provide labels translated into several different languages.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. Various features and advantages of the invention are set forth in the following claims.

1. A method of labeling a plurality of agricultural spray nozzle products using a base label, the method comprising:
providing a base label including a plurality of spray pattern icons in a first zone and a plurality of droplet size icons in a second zone:
providing a spray pattern indicator adjacent to one of the plurality of spray pattern icons; and
providing a droplet size indicator adjacent to one of the plurality of droplet size icons.

2. The method of claim 1 wherein the plurality of spray pattern icons includes at least two of a tapered fan, an even fan, a hollow cone, and a stream.

3. The method of claim 1 wherein the plurality of droplet size icons includes at least two of very fine, fine, medium, coarse, very coarse, and extremely coarse.

4. The method of claim 1 wherein the plurality of droplet size icons represent standard droplet size classes at a reference pressure of about three bar.

5. The method of claim 1 and further comprising providing the base label with a plurality of use icons in a third zone, and providing a use indicator adjacent to at least one of the plurality of use icons.

6. The method of claim 5 wherein the plurality of use icons include at least two of weed control, fertilizer application, plant disease control, and insect control.

7. The method of claim 1 and further comprising providing the base label with product information including at least one of product name, reference flow rate, reference pressure, spray pattern angle, quantity, part number, date, traceability information, and product codes.

8. The method of claim 1 and further comprising providing the base label with at least one product feature icon, and providing a product feature indicator adjacent to at least one of the at least one product feature icons.

9. The method of claim 8 wherein the at least one product feature icon includes twin spray pattern and air-induced spray.

10. The method of claim 1 and further comprising providing the base label with company website information.

11. The method of claim 1 and further comprising using the base label for packaging for a plurality of agricultural spray nozzle products by modifying positions of indicators adjacent to icons.

12. The method of claim 1 and further comprising using the base label for packaging for a plurality of agricultural spray nozzle products being sold in non-English speaking countries.

13. The method of claim 1 and further comprising providing a bar code on the base label.

14. A packaging system for a plurality of agricultural spray nozzle products, the packaging system comprising:
a base label including a plurality of spray pattern icons in a first zone and a plurality of droplet size icons in a second zone, the base label coupled to a package;
a spray pattern indicator provided on the base label adjacent to one of the plurality of spray pattern icons; and
a droplet size indicator provided on the base label adjacent to one of the plurality of droplet size icons.

15. The system of claim 14 wherein the plurality of spray pattern icons includes at least two of a tapered fan, an even fan, a hollow cone, and a stream.

16. The system of claim 14 wherein the plurality of droplet size icons includes at least two of very fine, fine, medium, course, very course, and extremely course.

17. The system of claim 14 wherein the plurality of droplet size icons represent standard droplet size classes at a reference pressure of about three bar.

18. The system of claim 14 wherein the base label includes a plurality of use icons in a third zone, and a use indicator is provided on the base label adjacent to at least one of the plurality of use icons.

19. The method of claim 18 wherein the plurality of use icons include at least two of weed control, fertilizer application, plant disease control, and insect control.

20. The system of claim 14 wherein the base label includes product information including at least one of product name, reference flow rate, reference pressure, spray pattern angle, quantity, part number, date, traceability information, and product codes.

21. The system of claim 14 wherein the base label includes at least one product feature icon, and a product feature indicator is provided adjacent to at least one of the at least one product feature icons.

22. The system of claim 21 wherein the at least one product feature icon includes twin spray pattern and air-induced spray.

23. The system of claim 14 wherein the base label includes company website information.

24. The system of claim 14 wherein the base label is used for packaging of a plurality of agricultural spray nozzle products by modifying positions of indicators adjacent to icons.

25. The system of claim 14 wherein the base label is used for packaging for a plurality of agricultural spray nozzle products being sold in non-English speaking countries.

26. The system of claim 14 wherein the base label includes a bar code.

27. A method of labeling a plurality of agricultural spray nozzle products using a base label, the method comprising:
providing a base label including a plurality of spray pattern icons in a first zone and a plurality of use icons in a second zone;
providing a spray pattern indicator adjacent to one of the plurality of spray pattern icons; and
providing a use indicator adjacent to at least one of the plurality of use icons.

28. The method of claim 27 wherein the plurality of spray pattern icons includes at least two of a tapered fan, an even fan, a hollow cone, and a stream.

29. The method of claim 27 wherein the plurality of use icons include at least two of weed control, fertilizer application, plant disease control, and insect control.

30. The method of claim 27 and further comprising providing the base label with product information including at least one of product name, reference flow rate, reference pressure, spray pattern angle, quantity, part number, date, traceability information, and product codes.

31. The method of claim 27 and further comprising providing the base label with at least one product feature icon, and providing a product feature indicator adjacent to at least one of the at least one product feature icons.

32. The method of claim 31 wherein the at least one product feature icon includes twin spray pattern and air-induced spray.

33. The method of claim 27 and further comprising providing the base label with company website information.

34. The method of claim 27 and further comprising using the base label for packaging for a plurality of agricultural spray nozzle products by modifying positions of indicators adjacent to icons.

35. The method of claim 27 and further comprising using the base label for packaging for a plurality of agricultural spray nozzle products being sold in non-English speaking countries.

36. The method of claim 27 and further comprising providing a bar code on the base label.
